(19) United States
(12) Patent Application Publication
(10) Pub. No.: US 2003/0076417 A1
(43) Pub. Date: Apr. 24, 2003

(54) Autonomous monitoring and tracking of vehicles in a parking lot to enforce payment rights

(76) Inventors: Patrick Thomas, San Diego, CA (US); Paul Thomas, Bellevue, WA (US); Brett Turner, Kirkland, WA (US); Byron Churchill, San Diego, CA (US); Chris Aldern, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/214,803

(22) Filed: Aug. 6, 2002

Related U.S. Application Data
(60) Provisional application No. 60/310,722, filed on Aug. 7, 2001.

(51) Int. Cl. H04N 5/225

(52) U.S. Cl. 348/169; 382/103

(57) ABSTRACT

A system and method that provide for automated enforcement of parking lot fee payments, thereby not requiring a human attendant to be present at each parking lot. The system and method utilize a camera or other sensing device, as well as pattern recognition technology, capable of monitoring and tracking vehicles in a parking lot. The system and method additionally provide a central control station capable of monitoring the status of the parking lots and fee payments, storing and archiving parking information, and generating alerts when vehicles are parked without payment. The system and method provide for parking lot revenue generation to be maximized by significantly reducing or eliminating vehicles parking without payment. In other embodiments, the system may be adapted for monitoring vehicle traffic in a zone of interest.

### RELATED APPLICATIONS

This application claims priority, under 35 U.S.C. §119(e), from U.S. Provisional Application No. 60/310,722, titled AUTONOMOUS MONITORING AND TRACKING OF VEHICLES IN A PARKING LOT TO ENFORCE PAYMENT RIGHTS, filed on Aug. 7, 2001, which is hereby incorporated in its entirety herein by reference.

### BACKGROUND OF THE INVENTION

1. Field of the Invention

The present invention generally relates to the field of object monitoring and tracking utilizing a sensing device. More particularly, the invention relates to providing a system and method for autonomously monitoring and tracking vehicles in a parking lot utilizing camera images and reporting certain events, for example vehicle movement or payment information, to computing devices via a network.

2. Description of the Related Technology

Most unattended parking lots generate revenue by requiring the vehicle driver parking in a space to place the payment for that space in either a particular slot in a locked box that corresponds to the individual parking space numbers, or present cash or a credit card to an electronic pay station that is capable of recording the payment. However, if no human attendant regularly checks the payment box or electronic pay station, payment for the use of the parking space is difficult and costly to validate and enforce. A roaming attendant that makes regular scheduled or random spot checks of such parking lots will not be able to discover and ticket a majority of the vehicles that do not make a proper payment. This likely results in a substantial loss of revenue from the operation of the parking lot.

### SUMMARY OF CERTAIN INVENTIVE ASPECTS

The present invention relates to a system and method whereby the parking lot fee collection and enforcement functions are automated without the need for a human attendant to continuously monitor each parking lot. Such a system and method allow for maximizing the amount of parking lot revenue generated by providing a cost-effective manner of validating and enforcing payment for space usage. One embodiment of the present invention additionally provides for signaling a roaming attendant, who is responsible for the enforcement of many parking lots, to a specific space in a specific parking lot if the system determines that a payment has not been made.

In one embodiment, the invention provides a system for tracking vehicles in a parking lot, the system comprising a vehicle sensing device configured to monitor movement of vehicles in the parking lot, a parking lot computer system configured to receive images from the vehicle sensing device, digitally process the images, and produce parking lot information, a pay station device configured to receive payment for parking spaces and transmit payment information to the parking lot computer system, a modem configured to transmit the parking lot information to a first data transfer service, a central computer and data storage system configured to receive the parking lot information from the first data transfer service, archive portions of the parking lot information, maintain a central database, communicate with a client computing device via a network, communicate with a credit card processing computing device via the network, and send lack of payment alerts to an attendant via a second data transfer service, and a central control station configured to receive portions of the parking lot information from the central computer and data storage system and perform monitoring functions of the parking lots.

In another embodiment, the invention provides a method of tracking vehicles in a parking lot, the method comprising monitoring movement of vehicles in the parking lot, receiving images of the monitored movement, digitally processing the images, and producing information indicative of parking lot status, receiving payment for parking spaces and transmitting payment information to another location, transmitting the parking lot status information to a first data transfer service, receiving the parking lot status information from the first data transfer service, archiving portions of the parking lot information, maintaining a central database, communicating with a client computing device via a network, communicating with a credit card processing computing device via the network, and sending lack of payment alerts to an attendant via a second data transfer service, and receiving portions of the parking lot status information from the central computer and data storage system and performing monitoring functions of the parking lots.

In another embodiment, the invention provides a method of tracking vehicles in a parking lot, the method comprising capturing a first image of the parking lot, transmitting the first image to a parking lot computing device, processing the first image so as to produce a second image of moving objects in the first image, processing the second image, including filtering vehicles based on size, so as to produce positions of recently-moved vehicles, comparing the positions of recently-moved vehicles to known lot space positions, identifying space positions with newly-arrived or departed vehicles; receiving lot payment information, determining if payment was received from the newly-arrived vehicles, and alerting an attendant if no payment was received from the newly-arrived vehicles.

In another embodiment, the invention provides a system for tracking vehicles in a parking lot, the system comprising a vehicle sensing device configured to generate a parking lot image, process the image, and produce parking lot information, a pay station device configured to receive payment for parking spaces and produce payment information, and a data processing system configured to receive parking lot information and payment information, and produce correlated information from the parking lot information and payment information. The embodiment further provides a system wherein the correlated information includes client information for display on a client computing device. The embodiment further provides a system wherein the correlated information includes parking lot monitoring information. The embodiment further provides a system wherein the correlated information includes payment deficiency alert information.

In another embodiment, the invention provides a method of tracking vehicles in a parking lot, the method comprising producing images of the parking lot, processing the images and producing parking lot information, receiving payment for parking spaces and producing payment information, receiving the parking lot information and payment information, and producing payment deficiency alert information.

In another embodiment, the invention provides a method of tracking vehicles in a parking lot, the method comprising generating an image of the parking lot, processing the image to produce newly-arrived vehicle position information, receiving lot payment information, determining if payment was received for the newly-arrived vehicle, and generating alert information if no payment was received for the newly-arrived vehicle. The embodiment further provides a method wherein processing the image further includes producing moving object information. The embodiment further provides a method wherein processing the image further includes producing space usage information.

In one embodiment, the invention concerns a system for detecting unauthorized use of a parking lot. The system comprises a sensing device that captures images of the parking lot and a payment device that receives payment input, wherein the payment input comprises information associated with payments for use of the parking lot. The system may further include a computing device for receiving the images and the payment input, and a software program executing on the computing device for processing the images to produce parking lot information, correlating the parking lot information with the payment input, and generating alert information when the parking lot information and the payment input do not correlate according to a predefined criterion.

Another aspect of the invention is directed to a method of detecting unauthorized use of a parking lot. The method comprises processing images of the parking lot to produce parking lot information, wherein the parking lot information comprises information about the movement of vehicles in the parking lot. The method may further comprise receiving payment for the use of parking spaces of the parking lot and based thereon producing payment information, and comparing the parking lot information with the payment information to determine unauthorized use of the parking lot.

Yet another aspect of the invention concerns a system for monitoring parking lot usage. The system comprises at least one image sensor directed at a parking lot, a processor receiving images from the at least one image sensor, and software executed by the processor to identify and track vehicles in the images and correlate the vehicle tracks with data indicative of payment for parking lot usage.

Although embodiments of the invention described here are principally directed to monitoring vehicles in a parking lot, it will be apparent to a person of ordinary skill in the relevant technology that the invention has wide applicability in the field of monitoring vehicle or pedestrian traffic. Hence, in one embodiment, the invention is directed to a method of monitoring status of vehicles in a zone of interest. The method comprises generating an image of vehicles in the zone of interest and processing the image to produce vehicle information. The method may further comprise comparing the vehicle position information to predetermined parameters associated with the zone of interest, and generating status information about the zone of interest or the vehicles in it based on the results of the comparison. The zone of interest may be a parking lot or parking structure. The processing of the image may comprise producing information associated with the number of vehicles that have entered, exited, or remain in the parking lot or parking structure. In another embodiment, the processing of the image may include producing information associated with either (i) the speed of a vehicle or (ii) the position of the vehicle with respect to a traffic light, or both.

### BRIEF DESCRIPTION OF THE DRAWINGS

The above and other aspects, features and advantages of the invention will be better understood by referring to the following detailed description, which should be read in conjunction with the accompanying drawings. These drawings and the associated description are provided to illustrate certain embodiments of the invention, and not to limit the scope of the invention.

FIG. 1 is a block diagram of a system architecture overview in accordance with one embodiment of the invention.

FIG. 2 is a flowchart of a process of monitoring, tracking and reporting vehicle movement to allow enforcement of fee payments, as performed on a system architecture such as shown in the embodiment of FIG. 1.

FIG. 3, is a high-level block diagram of a system for automatically tracking and correlating parking events with payment events in another embodiment of the invention.

FIG. 4 is a high-level flowchart of a method of automatically tracking and correlating parking events with payment events. The method may be used in conjunction with the system shown in FIG. 3.

FIG. 5 is a flowchart of a method, which may be used in conjunction with the method shown in FIG. 4, of recognizing and logging parking events.

FIG. 6 is a flowchart of a method, which may be used in conjunction with the method shown in FIG. 5, of capturing or retrieving parking lot information.

FIG. 7 is a flowchart of a method, which may be used in conjunction with the method shown in FIG. 5, of identifying, characterizing, and classifying structures of interest extracted from the parking lot information.

FIG. 8 is a flowchart of a method, which may be used in conjunction with the method shown in FIG. 5, of tracking the movement of the structures of interest.

FIG. 9 is a flowchart of a method, which may be used in conjunction with the method shown in FIG. 5, of analyzing the tracks of the structures of interest to determine parking events.

FIG. 10 is a flowchart of a method, which may be used in conjunction with the method shown in FIG. 9, of classifying tracks to determine parking events.

FIG. 11 is a flowchart of a method, which may be used in conjunction with the method shown in FIG. 7, of clearing from a difference image pixels associated with moving shadows.

FIG. 12 is a flowchart of a method, which may be used in conjunction with the method shown in FIG. 7, of identifying and characterizing structures of interest from the parking lot information.

FIG. 13 is a flowchart of a method, which may be used in conjunction with the method shown in FIG. 7, of classifying structures of interest identified from the parking lot information as vehicles or non-vehicles.

### DETAILED DESCRIPTION OF CERTAIN EMBODIMENTS

The following detailed description of certain embodiments presents various descriptions of specific embodiments of the present invention. However, the present invention can be embodied in a multitude of different ways as defined and covered by the claims. In this description, reference is made to the drawings wherein like parts are designated with like numerals throughout.

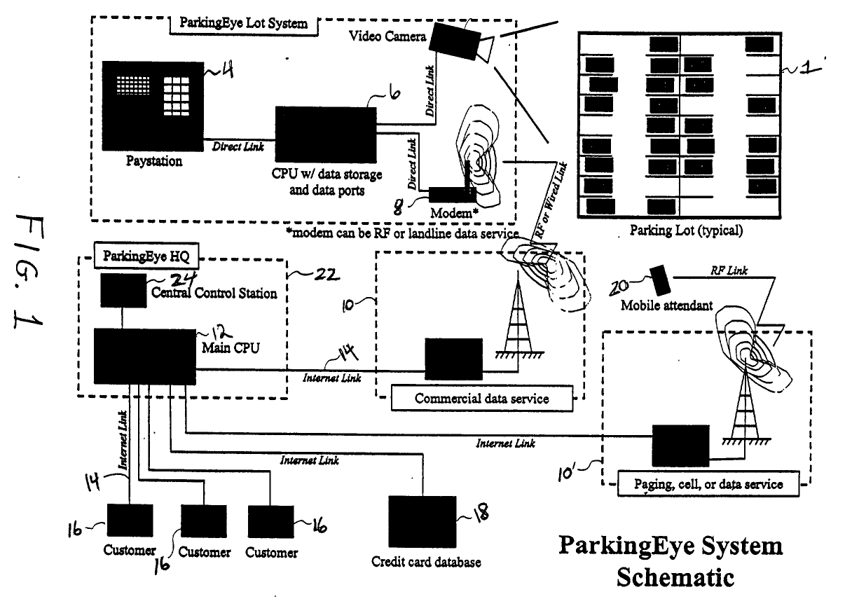

FIG. 1 is a block diagram of a system architecture overview in accordance with one embodiment of the invention. The embodiment shown in FIG. 1 includes a camera 2, for example an analog or digital video camera. In one embodiment, the camera is a video surveillance camera, which is capable of sending images at regular intervals, for example at least one image per second, via a direct link to a computer system. In other embodiments, the camera may be another type of optical sensing device, a radio frequency (RF) device, a radar, a pressure sensor, e.g. a piezoelectric device, an inductive sensor, or other device capable of sensing the presence or movement of objects such as vehicles.

The embodiment of FIG. 1 additionally includes a pay station device 4 that collects payments from parking lot customers. The pay station may additionally maintain an internal database (not shown) of parking lot information, for example, whether particular lot spaces are empty or occupied, payment amounts, and time and date information relating to certain lot events. The pay station may additionally include a communication port (not shown), such as a serial port or network connection, which allows external computers the ability to access the pay station database remotely.

The embodiment of FIG. 1 further includes a parking lot computing device 6 (labeled in FIG. 1 as “CPU w/ data storage and data ports”) that receives, via a communication port (not shown), payment information from the pay station 4 and/or image information from the camera sensing device 2. The parking lot computing device 6 of this embodiment executes one or more software program modules that process a current and one or more stored previous parking lot images and determine which lot spaces are empty and which are occupied by a vehicle. The parking lot computing device 6 may be capable of transmitting vehicle status information and/or payment information to other computing devices via a communication port.

The embodiment of FIG. 1 additionally includes a modem 8 or other device or program capable of transmitting data over a communications medium, such as a telephone line or data network connection. The modem device 8 allows the parking lot computing device 6 to transmit lot information, for example, data regarding the identification of the lot, status of the lot (e.g., number of cars and/or equipment operation status), selected images, or notification of lack of payment for any lot space. As described below, the modem device 8 may transmit data via a wireless data service (e.g., RF), landline data service, or other service capable of transferring data over long distances to a remote location such as a monitoring station.

The embodiment of FIG. 1 additionally includes a data service 10, for example, a wireless or landline data service. In one embodiment the data service 10 may be a commercial, third party data service that is available in the vicinity of the geographic location of the parking lot and that allows transmission of parking lot information from the individual lots to the data service system 10 via wireless or wired link. The data service 10 is capable of transmitting the information to other devices. In this embodiment, the data service 10 transmits the information to a central computing device 12 (described below) via a network 14, for example the Internet. In further embodiments, other communication mechanisms or protocols may be utilized.

The embodiment of FIG. 1 further includes a central computing device 12 (labeled in FIG. 1 as “Main CPU”), which may additionally include a data storage system (not shown), that receives information from the individual parking lots via the data service 10 (described above), displays or otherwise outputs the information, archives the information, and/or maintains a central database. The central computing device 12 may additionally communicate with a customer site computing device 16, also referred to as a client station, a credit card processing computing device 18, or a parking lot roaming attendant 20 to notify the attendant of a lack of payment alert. In this embodiment, the central computing device 12 and data storage system are located at a facility 22 that serves a central headquarters function for the parking lot monitoring and tracking system.

The embodiment of FIG. 1 additionally includes a central control station 24, which provides a monitoring function of the systems and modules comprising the parking lot monitoring and tracking system. This embodiment further includes a client station computing device 16 in data communication with the central computing device 12 (described above) via a network 14 such as the Internet. While the embodiment shown in FIG. 1 illustrates this connection as an Internet link, other network and communication links may also be utilized for data communication and thus are also within the scope of the present invention. In this embodiment, the client station 16 executes a web browser, for example, Netscape Navigator or Microsoft Internet Explorer. The client station may access the central computing device 12, also referred to herein as the headquarters data center, via a standard hypertext transfer protocol (HTTP) address. The use of HTTP addresses is widespread and will be understood by one of ordinary skill in the technologies relating to network communications protocols.

A user at the client station 16, having passed through the security protocol for access to the headquarters data center, may access information from each of the client's parking lots that are equipped with the parking lot monitoring and tracking system. The client additionally may access certain archived information, which may include, for example, camera or sensing device images, pay station revenue information, pay station summaries, pay station maintenance records and schedules, or overall parking lot statistical usage data stored at the headquarters data center.

The embodiment shown in FIG. 1 further includes an additional data service 10′ to allow the central computing device 12 to notify the mobile, roaming parking lot attendant 20 of a parking lot space payment alert. The central computing device 12 of this embodiment autonomously sends the alert notification message utilizing the additional data service 10′ to send the alert to a wireless system, for example, a pager, cell phone, or other wireless device. Although FIG. 1 shows the alerts being sent to the attendant via an RF link, additional embodiments may send the alert via other wireless or wired systems. The alert information may include the lot and space number for the space for which payment is lacking. While the additional data service 10′ is shown in the embodiment of FIG. 1 as a separate and distinct data service 10′ from the commercial data service 10, an embodiment in which these data services are combined into a single data service is likewise within the scope of the present invention. Upon receipt of such an alert, the mobile lot attendant 20, whose primary responsibility is to receive the lack of payment alerts indicating the specific parking lot and space number, verify the validity of the alert, for example, by visual inspection, and/or ticket or request towing of the offending vehicle.

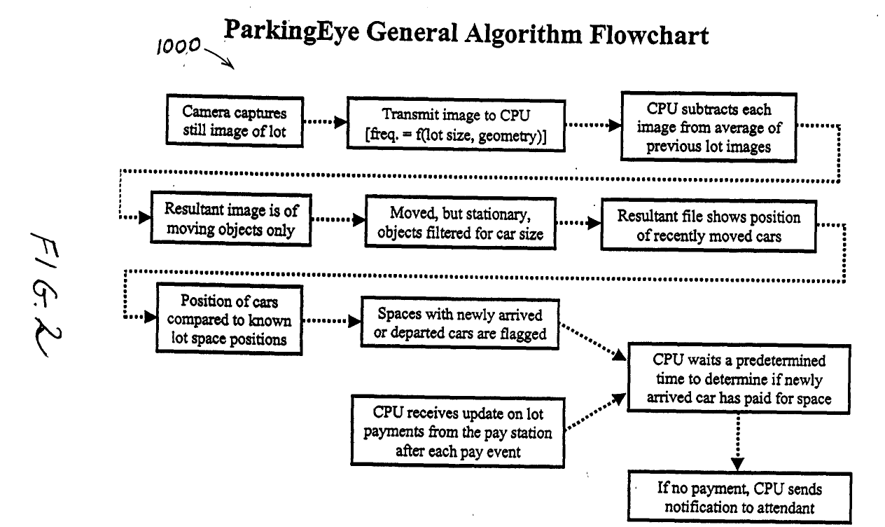

FIG. 2 is a flowchart of a process 1000 of monitoring, tracking and reporting vehicle movement to allow enforcement of fee payments, as performed on a system architecture such as shown in the embodiment of FIG. 1. In this embodiment, an electronic pay station 4 is mounted at the pedestrian entry/exit to the parking lot 1, or at another location convenient and visible to parking patrons. A camera 2 is mounted at the periphery of the parking lot at a height sufficient for a person with a similar point of view to be able to see and identify each space in the lot 1. Partially obstructed spaces or spaces in which the ground cannot be clearly viewed are acceptable as the system does not require an unhindered view. The camera 2 sends a still image or streamed video sequence of images of the parking lot 1 to a computer 6 located either at the lot, or alternatively it may be located off the lot 1 if the necessary communications infrastructure is provided. The lot computer 6 accepts new images from the camera 2 or sensing device at regular intervals, or at any interval the camera 2 may require to form and transmit the images. The frequency of the generation and transmission of the images may be dependent on the size of the lot 1, the number of vehicles being tracked, or other factors such as the amount of other distracting moving objects that are not vehicles in the field of view of the image, for example, trees blowing in the wind.

The lot computer 6 also is capable of receiving informational updates from the pay station 4 when a customer makes a payment for a particular lot 1 and parking space. In one embodiment, digital image processing algorithms are implemented in a software program and executed on the lot computer 6. Other embodiments in which the image processing algorithms are performed in hardware, otherwise hard-wired, using commercial off-the-shelf software, or performed in other manners are additionally within the scope of the present invention. These digital image processing algorithms use the parking lot images to identify moving objects on the lot 1, filter them by size, or identify when a moving vehicle of the appropriate size stops in a lot space and generate a parking lot event. The system may wait for an alterable, predetermined amount of time, if necessary, for the pay station 4 to signal that that space has received appropriate payment.

If no payment is received within the predetermined amount of time, the lot computer 6 of this embodiment sends a payment violation notice to the central computer 12. This notice may be sent via a modem 8 and a commercial data service 10, for example, a wireless (RF) system, a landline system, or other communication medium. The modem 8 may also be used to send regular updates of lot payments and occasional lot images to the central computer 12 at a rate that may be dependent on the modem bandwidth (typically measured in bits per sec).

Parking lot information for lots employing this system, which may include, for example, payment data, usage statistics, pay station status, lot images, or other lot information, is periodically sent to the central computer 12. The central control station 24 may include terminals and network equipment used to monitor the various lots and maintain communication links to the lots 1 and to any remote customer site that desires to download real-time and archival data for individual parking lots 1. The central computer 12 and central control station 24 additionally may send notifications via a paging, cellular, or other data service 10′ to a mobile lot attendant 20 to direct the attendant to payment violators or sites requiring service or maintenance. The attendant may also be notified, along with law enforcement authorities, if the camera 2 or sensor images at the lot indicate foul play, for example, theft of the pay station, vandalism of vehicles or parking lot property, or other crimes that may be under way at the parking lot 1.

Embodiments as shown in FIGS. 1 and 2 allow lot 1 to be left unattended, which lowers operating costs and additionally increases revenues from each lot by allowing violators to be ticketed before departing the lot 1, and also by providing incentives for the vehicle drivers to make prompt payment because they are aware of the continuous monitoring via signage, markings on the parking ticket stubs, and/or other forms of notice.

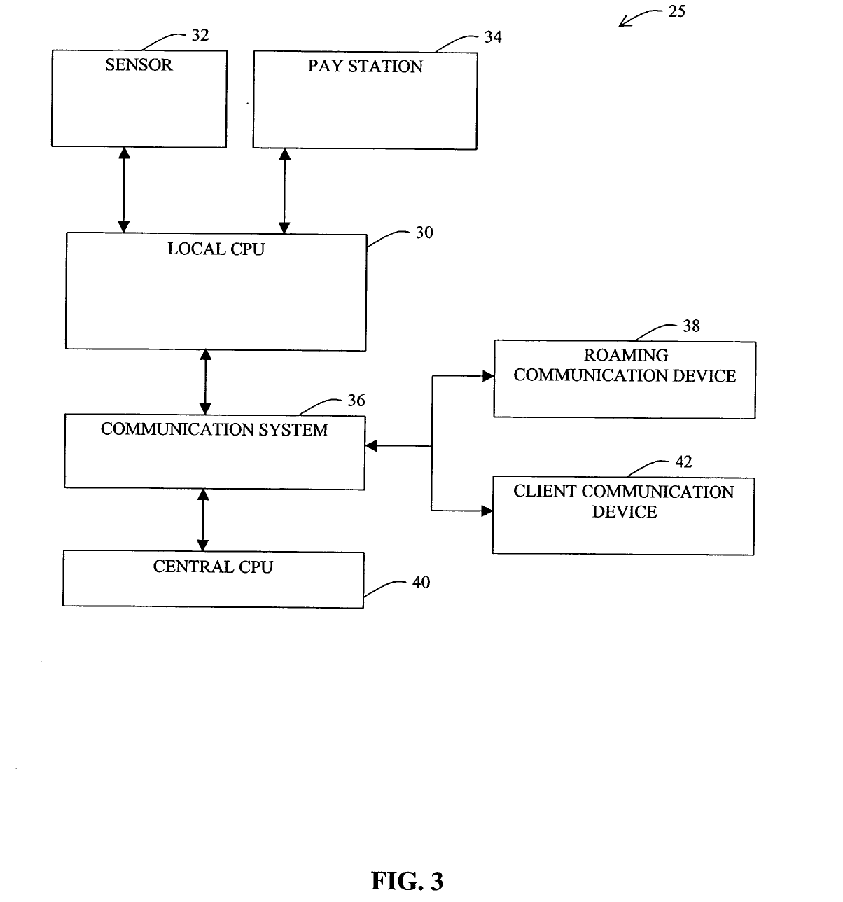

Other embodiments of the invention will now be described with reference to FIGS. 3 to 13. FIG. 3 is a high-level schematic diagram of a system 25 for automatically tracking and correlating parking events with payment events. A parking event is a predefined temporal and/or spatial state of a vehicle in a parking lot. For example, a parking event may be associated with a vehicle entering a parking lot, or parking in a parking space for a predetermined amount of time, or entering and leaving the parking lot within a predefined amount of time. A payment event is the receipt and recording of input by a pay station, for example, which input is associated with receiving a payment for the use of a parking space in a parking lot for a predetermined amount of time. The payment may be for a specific, designated space and/or for any amount of time, whether limited or unlimited.

The system 25 may comprise a computing device 30 (“local CPU”) located in the vicinity of the parking lot to be monitored. The local CPU 30 is in communication with a sensor 32 and a pay station 34 for receiving parking lot and payment event information, respectively. In one embodiment, the local CPU 30 may also be configured to interface with a communication system 36 in order to send and/or receive messages or commands from a central computing device 40 (“central CPU”), a roaming communication device 38, or a client communication device 42. It will be apparent to a person of ordinary skill in the relevant technology that a monitoring system 25 according to the invention need not include all of the components shown in FIG. 3. For example, in one embodiment, an adequate monitoring system 25 may comprise only the sensor 32, the local CPU 30 or the central CPU 40, the pay station 34, and the communication system 36.

The local CPU 30 may be a computing device having one or more microprocessors, input and/or output devices, one or more information storage devices, and a number of software/firmware modules for operation and control of these components. For example, in one particular embodiment, the local CPU 30 may have a 733 MHz Intel Pentium III microprocessor, a universal serial bus (USB) port, a serial port, 256 megabytes of random access memory, 40 gigabytes of hard disk drive memory, and run the operating system known as Windows NT 4.0. ITOX Inc. sells one such system under the brand name Baby Cobra.

In one embodiment, the local CPU 30 includes a modem (not shown) capable of transmitting and receiving data via the communication system 36. The modem allows the local CPU 30 to transmit parking lot information, such as a notification of lack of payment for any parking space. The modem may be, for example, a wireless Cisco Aironet® 350 Series modem which is capable of transmitting up to 11 megabits of data per second.

The sensor 32 is typically a device capable of capturing information about the state of a parking lot over a period of time. In one embodiment, the sensor 32 is configured to receive data associated with temperature variations for different spatial points of a parking lot. For example, sensor 32 may be an infrared sensor that detects heat emanating from the engines of cars in the parking lot. In another embodiment, the sensor 32 may be configured to sense and capture light input (i.e., an image) from the parking lot, and to create a digital version of the received image for access by a computing device, such as the local CPU 30. The sensor 32 may be, for example in a particular embodiment, a photographic digital camera such as the AXIS 2120 Network Camera sold by AXIS Communications. The AXIS 2120 camera uses 24-bit color, has a 704×480 pixel resolution, and has a built-in file transfer protocol server that allows a computing device to retrieve image data across a 100BaseT Network. In yet another embodiment, the infrared sensor and the digital camera functionality may be combined to produce parking lot information that combines the image data and the temperature variation data.

The pay station 34 is typically a device configured to collect payments from parking lot customers, and to transmit or make accessible electronic information associated with the payments; the information may include the amount of payment, time at which payment is made, identification of parking space associated with the payment, duration of use of a given parking space, etc. Dominion Self Park Systems, LTD., sells one such device under the brand name Vanguard. Other pay stations 34 available in the market include: Lexis Systems Inc., model 901LX; Digital Pioneer Technologies Corp., model Intella-Pay; and SchlumbergerSema, model Stelio Terminal.

The communication system 36 is typically a communications network that allows sending and receiving of information between any combination of the devices shown in FIG. 3. The communication system 36 may be for example, the public switched telephone network, a paging or cellular communications network, or a computer network such as the Internet.

The roaming communication device 38 may be a communication device that receives and/or transmits data at or from a non-fixed geographical location. In accordance with the invention, a roaming parking lot assistant typically uses the roaming communication device 38 to receive information about the state of the parking lot, such as when a parking violation has occurred. These devices are well known in the relevant technology, and include pagers, cellular phones, or personal digital assistants with built-in wireless or non-wireless communications capabilities. The client communication device 42 may be the same type of device as the roaming communication device 38. However, because typically the owner or manager of a parking lot employs the client communication device 42 to access information about the parking lot, the client communication device 42 may be equipped with more elaborate input/output components and communication features than the roaming communication device 38. The client communication device 42 may be, for example, a portable personal computer equipped with a wireless modem, or a personal computer capable of accessing the Internet.

The central CPU 40 may be a computing device having one or more microprocessors, input/output devices, data storage components, communications equipment, and software/firmware suitable for controlling these components. The central CPU 40 may be, for example, a server computer such as those sold by Compaq Computer Corp. or Dell Computer Corp.

Although not shown in FIG. 3, it will be apparent to the ordinary technician that the system 25 may comprise multiple local CPUs 30 with corresponding sensors 32 and pay stations 34 for monitoring multiple parking lots. These multiple CPUs 30 may be configured to communicate via the communication system 36 with the central CPU 40 for allowing the management and monitoring of multiple parking lots from a central location.

The general operation of system 25 will now be described briefly, with a more detailed discussion of the operation of certain of the components being presented below. The sensor 32 captures information about the state of the parking lot, including the movement of vehicles entering, stopping in, parking in, or exiting the parking lot. The sensor 32 may create digital files having images of the state of the parking lot at any given point in time. The pay station 34 receives input from a user of the parking lot; typically this occurs when a user access the pay station 34 to pay for use of the parking lot. The pay station 34 subsequently either forwards to the local CPU 30 data associated with the input, or alternatively, makes the data accessible for retrieval by the local CPU 30.

The local CPU 30 retrieves or receives from the sensor 32 the image data, and processes it to identify parking events. The local CPU 30 may then communicate parking and payment events to the central CPU 40, the roaming communication device 38, or the client communication device 42. In one embodiment, the local CPU 30 correlates the parking and payment events to determine whether a parking violation has taken place. If a parking violation occurs, the local CPU 30 sends a notification to the central CPU 40 and/or to the roaming communication device 38. In one embodiment, the central CPU 40 receives information from the local CPU 30 and displays or otherwise outputs the information, archives the information, and/or maintains a central database, hence, the central CPU 40 may be configured to serve as a central location for parking lot monitoring and for a parking lot data depository.

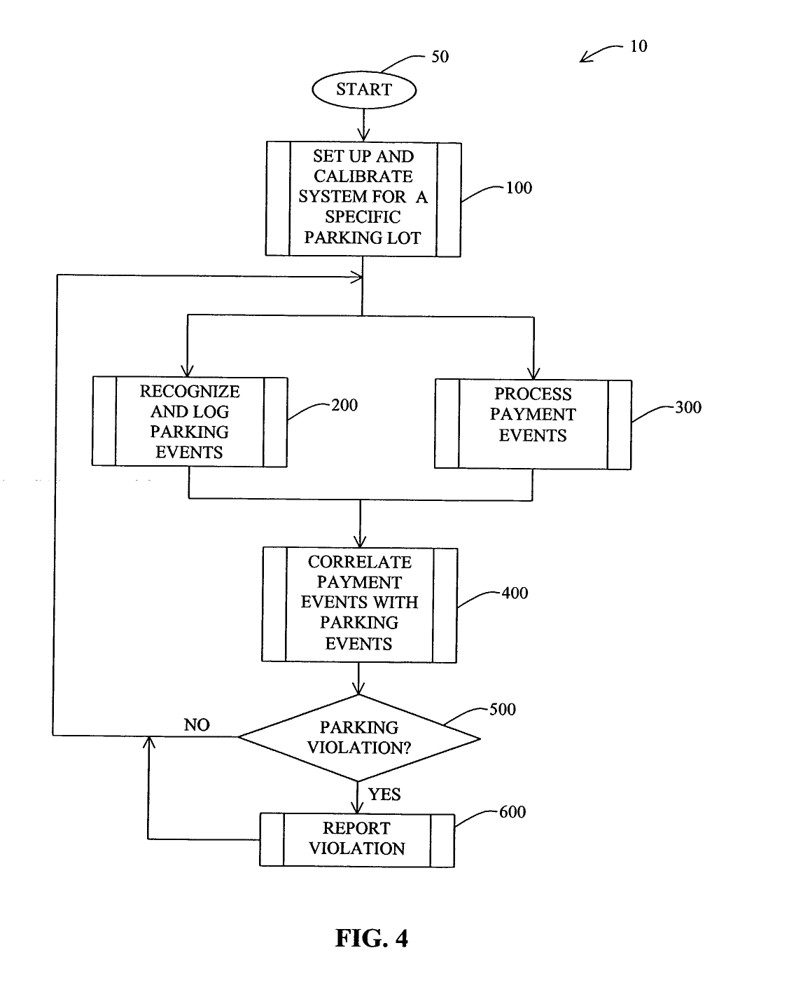

FIG. 4 depicts a high-level flowchart of a method 10 of automatically monitoring a parking lot to enforce payment for use of the parking lot. The method 10 begins at a start state 50. At a state 100, a monitoring system, e.g., system 25 of FIG. 3, is set up and calibrated for a specific parking lot. Information about a specific parking lot may include lot identification number, identification of each pay station 34 utilized in the parking lot, total number of parking spaces, x,y-coordinates on camera image of each parking space with corresponding space number, x,y-poligon definition of each access point, and x,y-poligon definition of a mask area. A person of ordinary skill in the relevant technology will appreciate that values for several calibration variables can only be determined through an empirical, but readily identifiable and manageable, process.

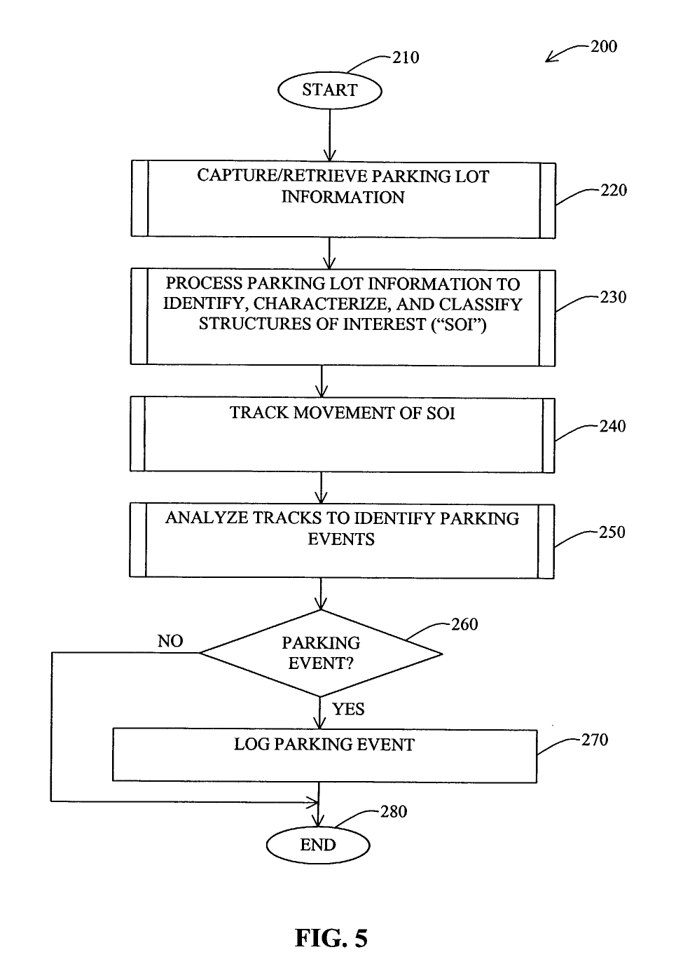

The method 10 may proceed to a state 200 or to a state 300, or as shown simultaneously perform the functions of those two states. At the state 200 the method 10 recognizes and logs parking events. In one embodiment, the local CPU 30 executes image processing modules to determine from the images captured by the sensor 32 whether, for example, a car has entered the parking lot, parked in a space, or left the parking lot. This image processing aspect of the method 10 will be discussed in greater detail below with reference to FIGS. 5 through 13.

At the state 300, the method 10 receives and processes input associated with the payment for use of the parking lot. The pay station 34 may maintain an internal database of parking lot information such as, for example, whether particular lot spaces are empty or occupied, payment amounts, and time and date information relating to payments. In one embodiment, a user of the parking lot provides payment to the pay station 34 in the form of currency or credit card authorization, and indicates the particular parking space paid for, as well as the length of time for using the parking space. The pay station confirms the amount of payment, the availability of the parking space, and the time at which the transaction has taken place. The pay station 34 communicates this information to the local CPU 30 via a communication port, such as a serial port, a wireless transceiver, or a network connection.

The method 10 proceeds to a state 400 where the system 25 correlates the parking event information with the payment event information. Techniques for carrying out the function of the method 10 at the state 400 are well known in the relevant technology and will not be discussed in detail here. Briefly, however, certain parking events such as a car parking in a given space, remaining for a certain period of time at the given space, and exiting the parking lot after a period of time, preferably have counterpart payment events, namely receipt of payment within a predefined length of time after the car has been at the parking space, amount of payment matching the length of time for which the car actually occupies the parking space, and expiration of usage time chosen by the user to match the time at which the car exits the parking lot.

At a decision state 500 of the method 10, the system 25 determines whether there has been a parking violation. There are well known techniques in the relevant field to perform this function and, hence, need not be described in detail. To determine whether a parking violation has occurred, software executing on the local CPU 30 analyzes the correlation of the parking events and the payment events to determine if there are mismatches. For example, if the system 25 generates a parking event because a car has been parked in a particular space of the parking lot, the system 25 should also generate a corresponding payment event within a certain period of time after generating the parking event. If the system 25 does not generate the payment event, because, for example, the user has not entered the appropriate input into the pay station 34 (e.g., has not provided the appropriate payment), the system 25 determines that a parking violation has occurred. If the system 25 determines that a parking violation has taken place, the method 10 moves to a state 600 where the system 25 forwards a notification of the parking violation to the central CPU 40 and/or the roaming communication device 38. If, however, the system 25 does not detect a parking violation, the process 10 returns to the state 200 and/or 300.

A skilled technologist in the relevant technology will readily recognize that the different states of the process 10 need not be performed in the exact sequence shown in FIG. 4. In fact, preferably the functions performed by the system 25 at states 200, 300, 400, 500, and 600 are performed substantially simultaneously since parking events and payments events may be ongoing, not particularly close in time, and even independent of each other.

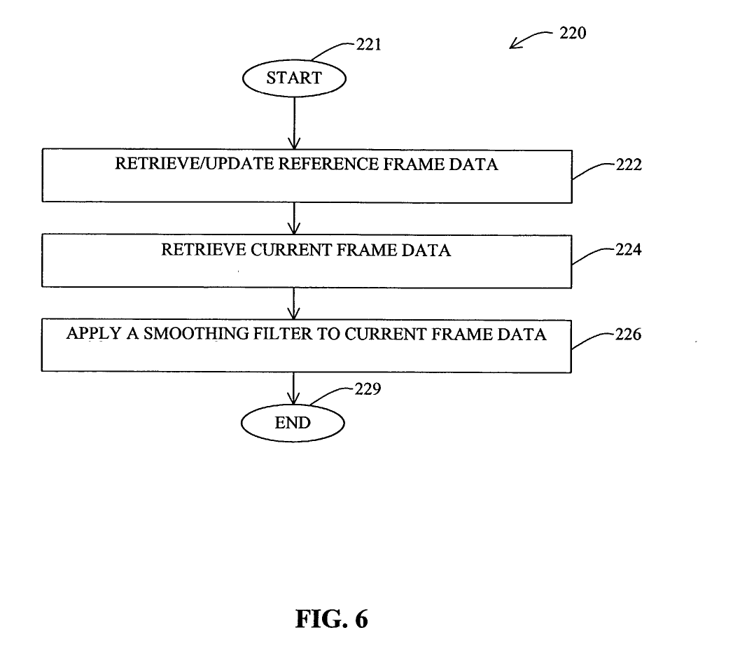

One exemplary embodiment that may be used to implement the state 200 of the method 10 will now be described in detail with reference to FIGS. 5 through 13. FIG. 5 is a high-level flowchart of an exemplary method 200 of recognizing and logging parking events. FIGS. 6 through 13 describe in greater detail exemplary subprocesses that may be used to implement the method 200.

In one embodiment, the method 200 begins at a state 210 after the system 25 has been set up and calibrated for monitoring a specific parking lot. At a state 220, the system 25 captures light input from the parking lot and produces digital images. For example, a digital camera converts the image information to a compressed digital, graphics data file. In another embodiment, the local CPU 30 may directly retrieve or receive digital data from any sensing device capable of capturing information about the state of the parking lot. The functions that the system 25 performs at the state 220 are further described below with reference to FIG. 6.

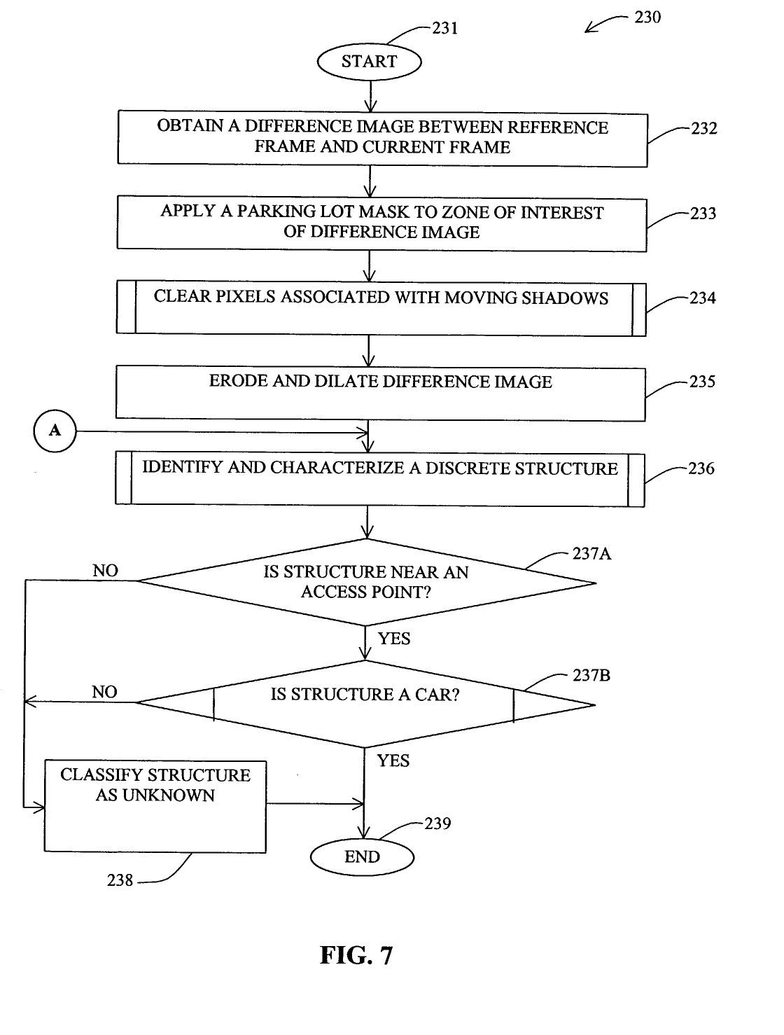

At a state 230, the local CPU 30 uses image processing algorithms to analyze the images representing the parking lot information to identify, characterize, and classify structures of interest (“SOI”). Briefly, the image processing algorithms determine whether the image information shows structures indicating that there are moving objects in the parking lot, characterize the structures in terms of its geometric or chromatic features, and classify the structure. The SOI may be classified as a “car” when the structure is determined to be substantially similar to a car, or as “unknown” when the structure cannot be determined to be a “car” but should not be ignored since it may turn out to be a “car” upon further observation. The functions the system 25 performs at the state 230 of method 200 are further described below with reference to FIGS. 7, 11, 12 and 13.

The method 200 may also comprise a state 240 where the system 25 tracks the movement of the SOI. For each SOI identified at the state 230, the system 25 may assign a data record for following the behavior of the SOI across multiple, sequential images captured by the sensor 32. For convenience of description, the set of multiple, sequential images comprising a history of the movement of the SOI may be referred to as a “track.”

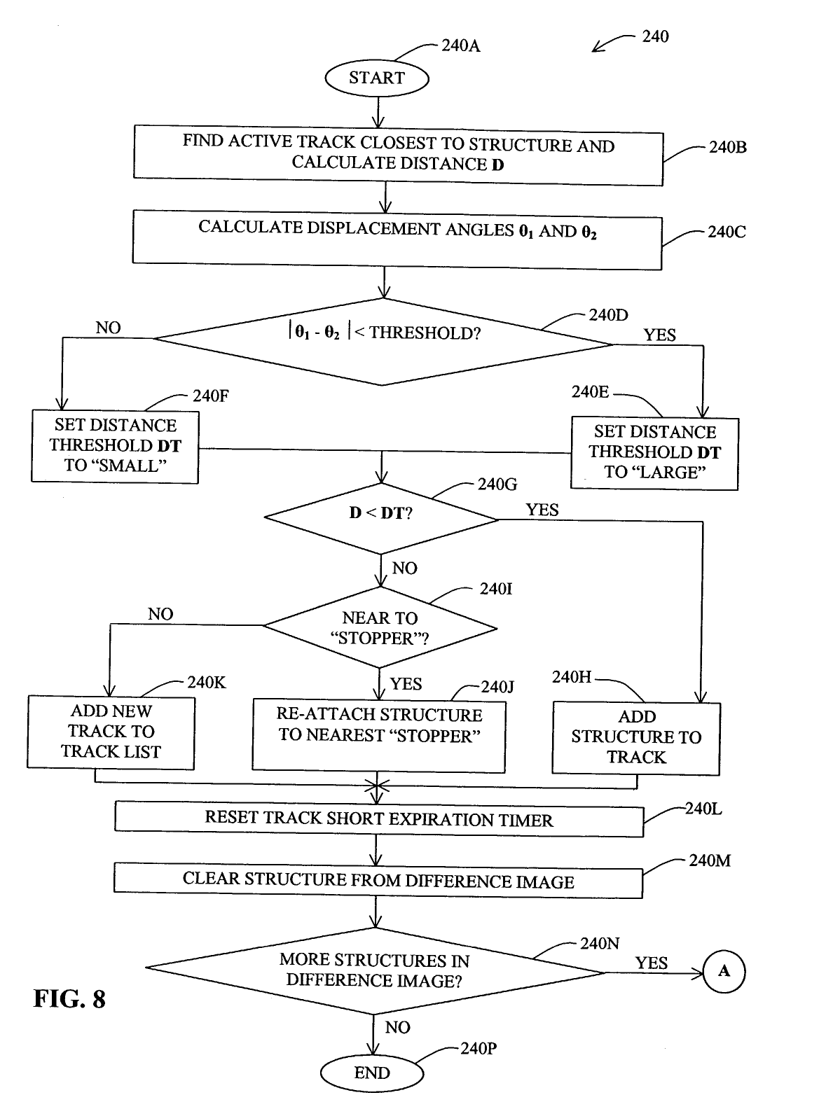

When the system 25 identifies a SOI in an image under analysis, the system 25 attempts to match the SOI to an existing track. If a match is made, the image of the SOI is added to the existing track. However, if no match is found, the system 25 creates a new track for following the SOI extracted from the image. The functions performed at the state 240 of method 200 are further described below with reference to FIG. 8.

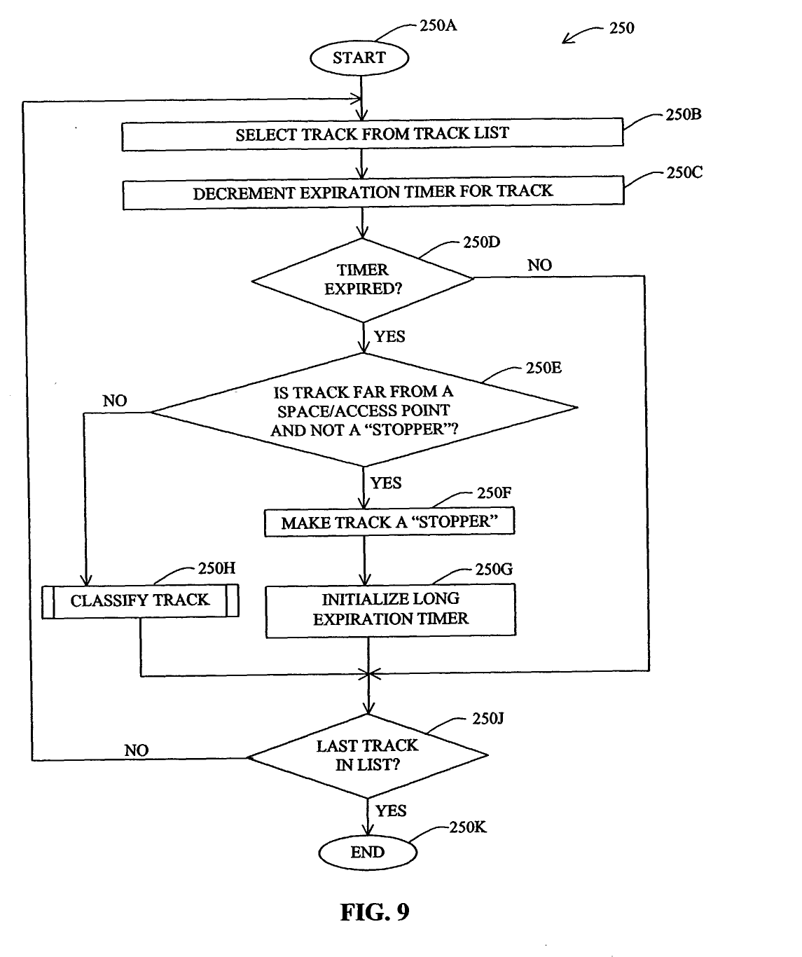

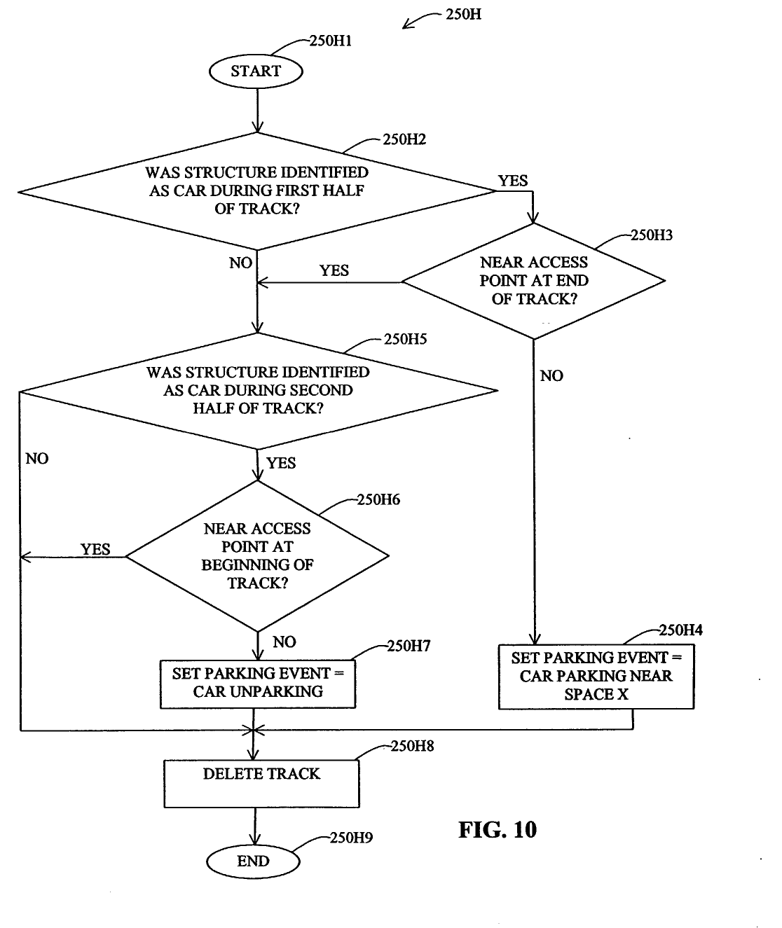

The method 200 may comprise a state 250 where the system 25 identifies parking events by analyzing the tracks of the SOI. In one embodiment, which is described in detail below with reference to FIGS. 9 and 10, the system 25 classifies a track as a “stopper” (meaning that the SOI followed by the track has not moved within a predetermined period of time), or deletes a given track after determining that the track indicates that a car either parked in or left a parking space. When the system 25 determines that a SOI classified as a “car” has stopped near a certain parking space for a predetermined period of time, the system 25 generates a parking event, e.g., parking event=“car” parked at space×at time 0800 hours. Similarly, when the system 25 determines that a SOI of interest classified as a “car” has exited the parking lot, the system 25 may generate an appropriate parking event, e.g., parking event=“car” left parking lot at time 0900 hours.

At a decision state 260 of the method 200, the system 25 determines whether a parking event has occurred. If the system 25 generates a parking event, it logs the parking event at a state 270. The system 25 may, for example, make an entry in a table or database of the local CPU 30, or forward the parking event data from the local CPU 30 to the central CPU 40. The method 200 next proceeds to an end state 280, where the process flow may continue at the state 400 of the method 10 shown in FIG. 4.

FIG. 6 is a flowchart illustrating an exemplary method 220 of capturing or retrieving parking lot information. The method 220 may be part of the method 200 shown in FIG. 5. The method 220 begins at a state 221 and proceeds to a state 222. At the state 222 the system 25 retrieves a “reference frame” having information about the status of objects in the parking lot. Immediately upon starting operation of the system 25, the sensor 32 captures an image of the parking lot, and this first image may be deemed the “reference frame.” However, the reference frame may be a steady-state image of the parking lot captured when there are no moving objects in the parking lot that may result in SOI. This image could be designated as the reference frame for beginning operation of the system 25. In one embodiment, once the system 25 has begun operation, the reference frame is the image previous to the most current frame captured by the sensor 32.

In other embodiments, the reference frame may be an “average image” derived from averaging the properties of the pixels in the images over a certain number of previous, sequential images. Hence, at the state 222, the system 25 may retrieve or update the reference frame in one of several ways. The reference frame is represented in digital, image data such as, for example, the well known Red, Green, Blue (“RGB”) values of each pixel in the image.

The method 220 next proceeds to a state 224 where the system 225 retrieves the “current frame” data. The “current frame” data is digital, image information (e.g., RGB values) representing the most recent image of the state of the parking lot captured by the sensor 32. At a state 226, the system 25 may enhance the current frame data by applying a smoothing filter to reduce noise in the data. Image enhancing filters are well known in the relevant technology. One example of such filters may be found in Jain R., et al., Machine Vision, pp. 120-122 (McGraw-Hill, New York, 1995). It will be apparent to the ordinary technician that the image enhancing filters may also be preferably applied to the reference frame data. The method 220 ends at a state 229, where the process flow may proceed to the state 230 of the method 200 shown in FIG. 5.

FIG. 7 is a flowchart of a method 230 of processing parking lot information to identify, characterize, and classify SOI. The method 230 is an exemplary way of performing the functions at the state 230 of the method 200 shown in FIG. 5. The method 230 begins at a state 231 after, for example, the system 25 has retrieved and enhanced the reference frame and the current frame data. At a state 232 the system derives a difference image from comparing the current frame against the reference frame, or vice versa. In one embodiment, the system 225 evaluates a difference function between each pixel in the current frame and the corresponding pixel in the reference frame. The difference function may be any scalar valued function including, but not limited to, a standard Euclidean distance or the sum of absolute differences between the red, green, and blue components of the respective pixels in the current and reference frames. In one embodiment, the system 25 may further process the difference frame to produce a black and white (i.e., binary) “difference image.” For example, the system 25 may obtain the binary difference image by requiring that the difference between corresponding pixels of the current and reference frames exceed a certain threshold. This threshold may depend on the lighting conditions for a given parking lot and/or various hardware settings, for example.

The method 230 next proceeds to a state 233 where the system 25 applies a “lot mask” to the difference image. Typically the sensor 32 captures images that include not only a “zone of interest,” i.e., the parking lot itself, but also the vicinity of the zone of interest. For example, if the sensor 32 is a digital, photographic camera, it may capture images of the parking lot where a certain percentage of the image falls outside the zone of interest. The percentage that falls outside the zone of interest typically depends on the location and elevation of the camera relative to the location and geometry of the parking lot to be monitored. Preferably pixels that represent areas outside the zone of interest are removed from consideration in the image analysis by applying an empirically determined “lot mask” to the difference image. The lot mask is configured such that only pixels within the zone of interest remain in the difference image after application of the lot mask to the difference image. The application of a mask to image data is a technique well known in the relevant technology and will not be described further.

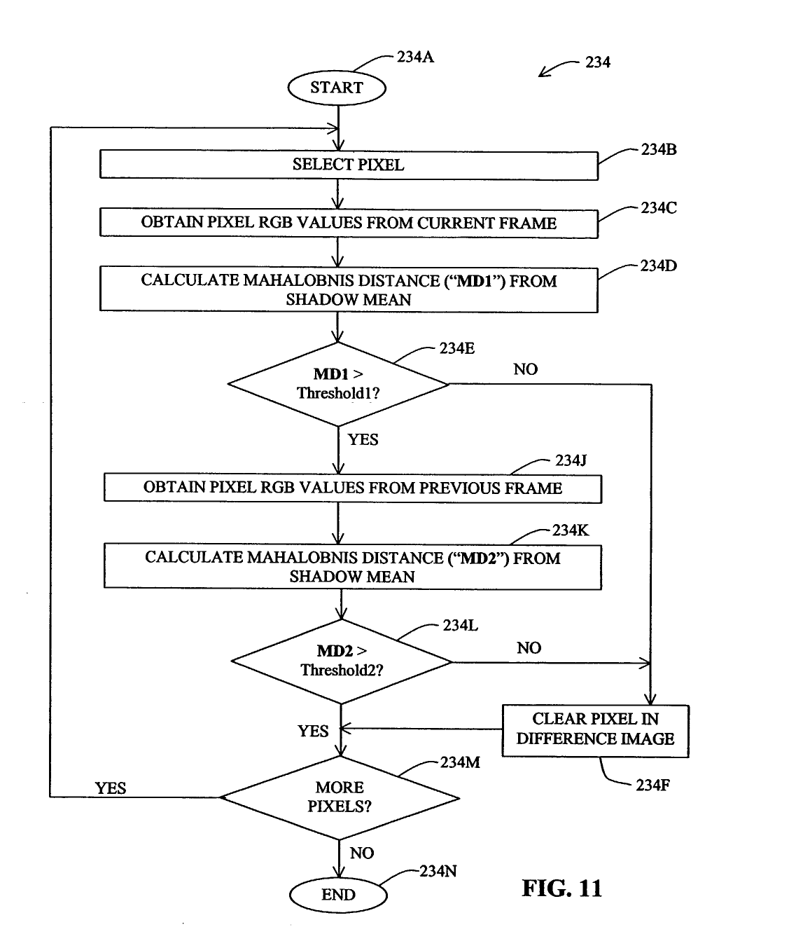

At a state 234, the image processing modules of the system 25 may further process the binary difference image by applying a shadow removal function to the difference image data. The system 25 removes from the image difference pixels that are determined to represent shadows cast by moving objects. An exemplary manner of carrying out this function is described below in further detail with reference to FIG. 11. The method 230 continues at a state 235 where the system 25 may further process the difference image by applying erosion and dilation functions to the difference image. These operations on the binary difference image remove isolated pixels and/or small structures, and fill in areas with voids. The result of these operations is that moving objects in the parking lot may be represented in the difference image as single, solid structures made of connected pixels. Erosion and dilation techniques are well known in the relevant field. For example, erosion and dilation algorithms are discussed in Gonzalez, R. C., et al., Digital Image Processing, pp. 518-524 (Addison-Wesley, Massachusetts, 1992).

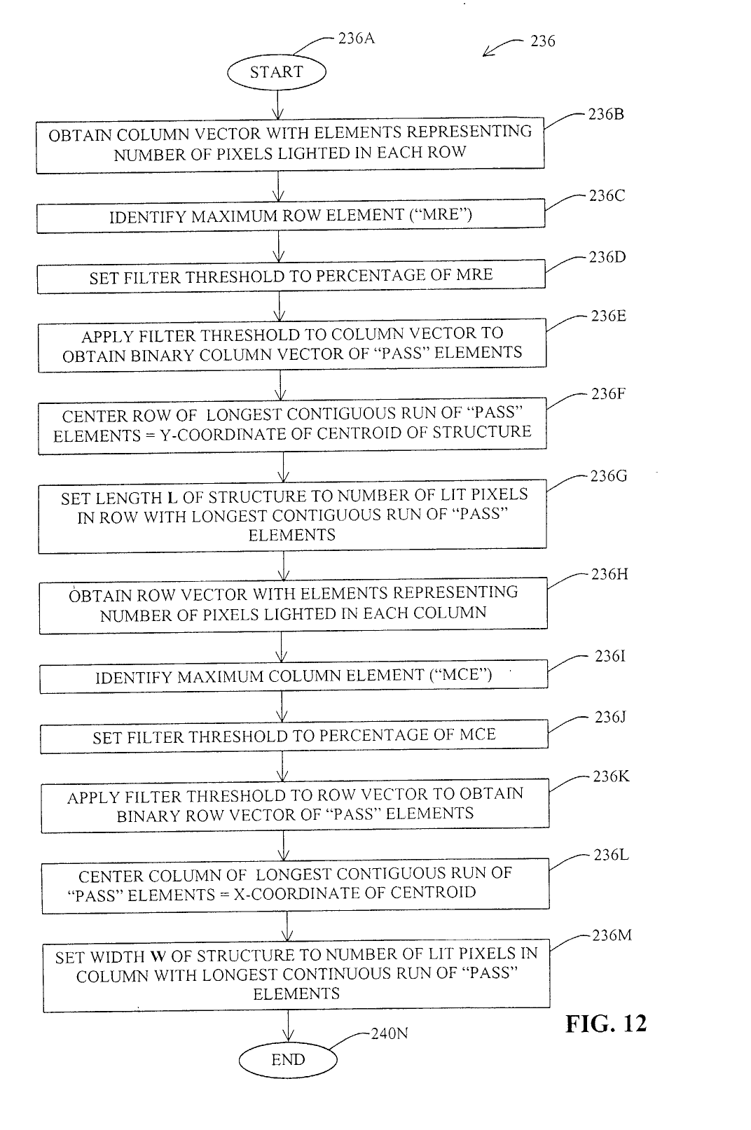

At a state 236, the system 25 identifies and characterizes discrete structures of interest (“SOI”), which represent significant moving objects captured in the images. The system 25 may connect, i.e., associate to each other, pixels in the 4- or 8-neighbor sense to produce a discrete structure. The system assigns unique identifiers to each SOI and to each pixel forming the SOI. At the state 236, the system 25 also determines several geometric measures and characteristics of the SOI. One manner identifying and characterizing the SOI is described below with reference to FIG. 12.

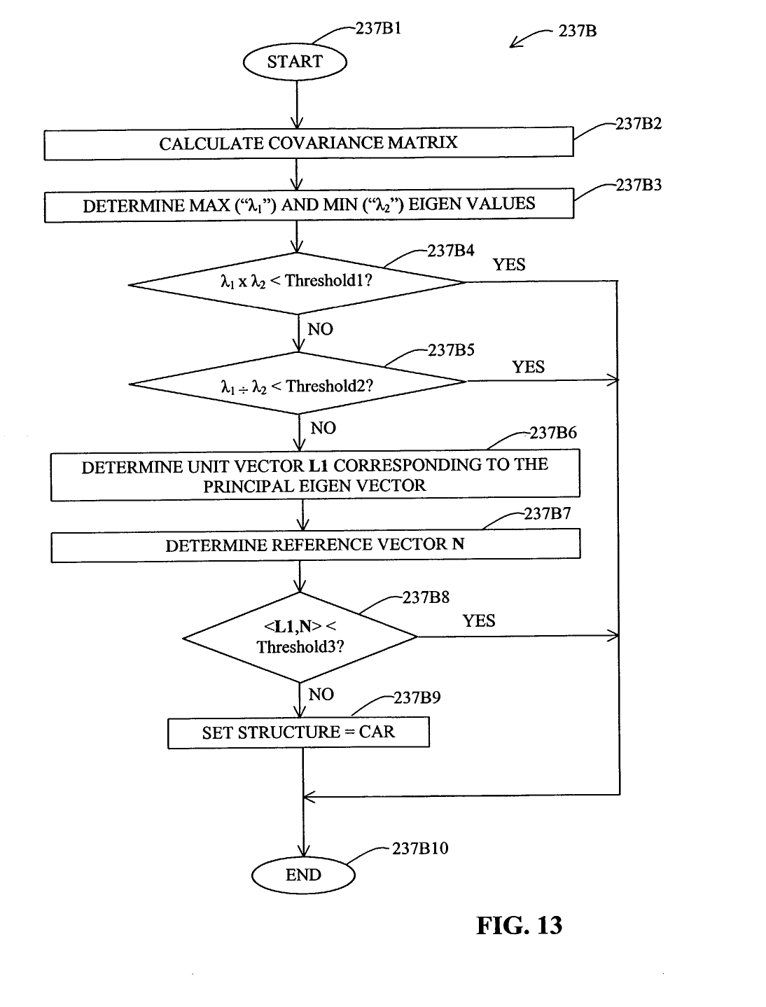

At a decision state 237A, the system 25 determines whether the structure is near an “access point” of the parking lot. An access point of the parking lot is a designated area of the parking lot that automobiles may use for access into or egress from the parking lot. The image processing modules of the system 25 are configured with the appropriate data such that the access points of the parking lot are associated with corresponding areas of the difference image. If the system 25 determines at the decision state 237A that the SOI is near an access point, the process 230 moves to a decision state 237B to determine whether the SOI represents a “car,” i.e., the SOI exhibits properties that indicate a moving automobile in the parking lot. A process of analyzing the properties of the structure to determine whether it is car-like is described below with reference to FIG. 13. If the system 25 determines that the structure is a “car,” it ends at a state 239 where the flow of process may continue at the state 240 of the method 200 shown in FIG. 5. If the system 25 determines at the decision state 237A that the structure is not near an access point, or at the decision state 237B that the structure is not a “car,” the process 230 proceeds to a state 238 where the structure is classified as “unknown” and a track is added for following the structure through subsequent frames. The process 230 ends at the state 239.

FIG. 8 is a flowchart of an exemplary process 240 for following one or more SOI through a series of frames, i.e., each SOI is associated with a “track” that is made of the difference frames in which the SOI appears. The objective of the process 240 is to match a SOI with an existing track, begin a new track for a SOI of interest which cannot be matched to an existing track, or to associate a SOI with a corresponding “stopper” track. The process 240 begins at a state 240A, and proceeds to a state 240B where the system 25 identifies from the track list the track that is “closest” to the SOI. At the state 240B the “stopper” tracks are not considered. The SOI in the last frame of a given track has a location in the difference image given by its centroid. It is this location that is compared to the location, in the current frame, of the centroid of the SOI under analysis. The system 25 chooses for further analysis the track where the distance between the centroid of the SOI of interest in the last frame of the track and the centroid of the SOI in the difference image is the least.

To provide further confirmation that a SOI matches the track that is closest to it, two displacement angles may be calculated to test whether the distance between the centroid of the SOI in the difference image and the centroid of the SOI in the last frame of the track is within acceptable limits. At a state 240C the system 25 calculates displacement angles θ₁ and θ₂. The angle θ₁ is the polar angle of the vector that connects the centroid of the SOI in the last frame of the track and the centroid of the SOI in the difference image. The angle θ₂ is the polar angle of the vector that connects the centroid of the SOI in the last frame of the track and the centroid of the SOI in the frame immediately before the last frame of the track, i.e., the vector connects the centroids of the SOI in the last two frames of the track. Inferences about the motion of the SOI can be made based on the size of the displacement angles. For example, where the SOI is moving in substantially a straight line, the displacement angles between the centroids of the SOI in the respective frames should be small, approximating zero. Conversely, when the SOI is turning the displacement angles should increase with the size and speed of the turn. Additionally, if the SOI is moving in a straight line it may be assumed that, compared to a turning SOI, it covers a relatively larger distance between frames.

At a decision state 240D, the system 25 determines whether the difference between θ₁ and θ₂ is less than a threshold angle. In one embodiment, the threshold angle may be set preferably to about 70°, but may range from about 30° to 85°. When the difference between θ₁ and θ₂ is less than the threshold angle, it is assumed that the SOI is moving in a straight line and, consequently, the distance between the centroids of the SOI in the frames under analysis is assumed to be “large.” Hence, if the difference between θ₁ and θ₂ is less than the threshold angle, the system 25 sets a distance threshold DT to “large” at a state 240E. Conversely, if the difference between θ₁ and θ₂ is less than the threshold angle, the system 25 sets the distance threshold DT to “small” at a state 240F. An exemplary, relative value for “large” is about 150 pixels, and for “small” is about 95 pixels. Of course, these values are only exemplary, and the ordinary technician will appreciate that the exact value will depend on the parking lot conditions and the hardware employed.

The process 240 moves to a decision state 240G where the system 25 determines whether the distance D, between the centroid of the SOI of the difference image and the centroid of the SOI of the last frame of the track, is less than the distance threshold DT. If D<DT, the system 25 assumes that a match has been found and assigns the SOI under analysis to the track. That is, the system 25 determines that the centroid of the SOI is “close” enough to the track that it belongs to that track.

If, at the decision state 240G, the system 25 determines that D is not less than DT, the process 240 moves to a decision state 2401 where the system 25 determines whether the centroid of the SOI is “near” to a stopper track. An exemplary, but not limiting, value for “near” in one embodiment is about 41 pixels. If the centroid of the SOI is near to a stopper track, the system 25 assigns the SOI to the stopper track at a state 240J. If the centroid of the SOI is not near to a stopper track, the system 25 proceeds to a state 240K where it adds a new track to the track list in order to follow the SOI through subsequent images. That is, if there was no track having a last frame showing a SOI with a centroid close to the centroid of the SOI, and there was no “stopper” track close to the SOI, the system 25 determines that there was no match and a new track must be assigned to the SOI.

The process 240 next proceeds to a state 240L where the system 25 resets the appropriate expiration timer. In the case where a new track is added to the list, the “long” expiration timer begins at, for example, 100 frames. That is, this new track will be kept for one-hundred frames, before the track is classified as a stopper, if there is no activity in the track. If the SOI is attached to a stopper at the state 240J, the “short” expiration timer begins at, for example, 10 frames. The “short” expiration timer is used to countdown before an “active” track is labeled a stopper.

The process 240 continues at a state 240M where the system 25 clears the SOI from the difference image. At a decision state 240N, the system 25 determines whether there are remaining SOI in the difference image to be analyzed. If there are additional SOI in the difference image, the process 240 moves via the off-page indicator “A” to the state 236 of the process 230 shown in FIG. 7. The system 25 executes the process of identifying and characterizing the next SOI from the difference image, as already described above. If there are no more SOI in the difference image to be analyzed, the process 240 ends at a state 240P where the process flow may continue at the state 250 of the process 200 shown in FIG. 5.

FIG. 9 is a flowchart of a process 250 of analyzing the tracks of the SOI in order to identify the occurrence of parking events. The process 250 begins at a state 250A, and proceeds to a state 250B where the system 25 selects a track from the track list for analysis. In one embodiment, the system 25 chooses the first track in the track list table or database. The process continues to a state 250C where the system 25 decrements the “expiration timer” for the track; if the “expiration timer” units are frames, the system 25 decrements the timer by one frame.

At a decision state 250D, the system 25 determines whether the timer for the track has expired. If the timer has expired, the system 25 moves to the decision state 250J where it determines whether the track under analysis is the last track in the list. If the track under analysis is the last track, the process 250 ends at a state 250K; otherwise, the process 250 returns to the state 250B. If at the decision state 250D, the system 25 determines that the timer for the track has not expired, the process 250 proceeds to a decision state 250E.

At the decision state 250E, the system 25 determines whether the centroid of the SOI in the last frame of the track is “far” from an access point or a designated parking space, and whether the track is also not a stopper. In one embodiment, an exemplary value for “far” is about 81 pixels. If both conditions are met, the process 250 continues at a state 250F where the system 25 makes the track a stopper track. That is, the system 25 makes the track a stopper because the timer for the track has expired, the track is not a stopper, and is far from a parking space or an access point. This represents a situation where the SOI has not moved for some period of time; however, since the SOI is not near a parking space or an access point, the system 25 cannot tag the track as a parking event, such as a car that has parked near a designated parking space or has exited the parking lot. After the system 25 tags the track as a stopper at the state 250F, the process moves to a state 250G where the system 25 initializes the “long” expiration timer for the new stopper track. The process continues to the decision state 250J where the system 25 determines whether the track under analysis is the last track in the list. If so, the process 250 ends at the state 250K; otherwise, the process returns to the state 250B.

If at the decision state 250E the system 25 determines that the track is either not far from a space or access point, or that the track is a stopper, the process 250E moves to a state 250H. At the state 250H the system classifies the track according to the parking event that it indicates. One exemplary method of determining the parking event by analyzing the tracks, as well as the characteristics of the SOI within the tracks, is described below with reference to FIG. 10. The process 250 continues at the decision state 250J, where the system 25 determines whether the track is the last track in the list. If the track is not the last track in the list, the process returns to the state 250B; otherwise, the process ends at the state 250K where the process flow may continue at the decision state 260 of the process 200 shown in FIG. 5.

FIG. 10 is flowchart of a process 250H for determining the occurrence of parking events by analyzing the tracks of SOI. The process 250H is an exemplary method that may be used in conjunction with the process 250 of FIG. 9. The process 250H begins at a state 250H1. At a decision state 250H2, the system 25 determines whether the SOI appearing in the track was identified as a “car” during the first half of the track, i.e., within the first half of the set of frames making up the track. If the SOI was so identified, the process 250H moves to a decision state 250H3 where the system 25 determines whether the centroid of the SOI in the last frame of the track is near an access point. If the centroid of the SOI is not near an access point, the system 25 determines that the track indicates that a car has parked near a designated parking space. The system 25 may, for example, set a variable “parking event” to indicate “car parking near space X.” This process represents a situation where the system 25 has previously tagged the track as a stopper (state 250F of FIG. 9), the timer on the stopper track has expired indicating that there has not been activity on that track for some time (state 250D of FIG. 9), the SOI associated with the track was identified as “car” during the first half of the track (“yes” at state 250H2), and the centroid of the SOI in the last frame of the track was not near an access point (“no” at state 250H3), which implies that the centroid of the SOI in the last frame of the track was near a parking space. Hence, it is concluded that the “car” has parked, and the system 25 indicates so accordingly. The process 250H deletes the track at a state 250H8, and terminates at an end state 250H9.

If at the decision state 250H2 the system 25 determines that it did not identify the SOI as a “car” during the first half of the track, or that it did so identify the SOI but that the centroid of the SOI was near an access point in the last frame of the track (“yes” at state 250H3), the process 250H proceeds to a decision state 250H5. The system 25 determines at the decision state 250H5 whether the SOI was identified as a “car” during the second half of the track, i.e., in any of the frames from the group of frames constituting the second half of the frames of the track. If the SOI was not identified as “car” during the first half of the track (“no” at state 250H2), and it was not identified as a “car” during the second half of the track (“no” at state 250H5), this indicates that the system 25 detected but did not classify the object as a “car” at any point during the tracking of its movement. Thus, the system 25 tracked the object as an “unknown” SOI, did not observe the object move for some period of time (i.e., the track became a “stopper track”), and the track's “long” timer eventually expired. Under these circumstances, the system 25 does not consider the track to indicate a parking event, and the system 25 deletes the track at the state 250H8 before ending at the state 250H9.

If the system 25 determines at the decision state 250H5 that the SOI was identified as “car” during the second half the track, the process 250H moves to a decision state 250H6 where the system determines whether the centroid of the SOI in the first frame of the track is near an access point. If such is the case, the system 25 determines that the track does not indicate a parking event and deletes the track at a state 250H8 before ending at the state 250H9. This process represents a set of circumstances where, as a first case, the SOI was not identified as “car” during the first half of the track (“no” at state 250H2), was determined to be a “car” during the second half of the track (“yes” at state 250H5), and its centroid was near an access point at the beginning of the track (“yes” at state 250H6). In this case, although the system 25 identified the SOI as a “car,” the system 25 does not consider the track to indicate a parking event. Hence, the track is deleted. In the second case, the SOI was identified as a “car” in the first half of the track (“yes” at state 250H2), was near an access point in the last frame of the track (“yes” at state 250H3), was identified as a “car” in the second half of the track (“yes” at state 250H5), and was near an access point in the first frame of the track (“yes” at state 250H6). This latter case may be thought of as a “drive through” because the SOI was observed during the track as a moving “car” that entered and exited the lot, with the track eventually becoming a stopper with an expired timer. In this case the system 25 deletes the track from the track list without generating a parking event.

If at the decision state 250H6 the system 25 determines that the centroid of the SOI in the first frame of the track was not near an access point, the system 25 sets the “parking event” variable to “car unparking.” This means that the track indicates that a car has left a parking space and is exiting, or has exited, the parking lot. This results follows from the circumstances where, as a first case, the SOI was identified as car during the first half of the track (“yes” at state 250H2), its centroid was near an access point in the last frame of the track (“yes” at state 250H3), was identified as car during the second half of the track (“yes” at state 250H5), and its centroid was not near an access point in the first frame of the track (“no” at state 250H6). This indicates a car that starts from a stopped position in a parking space and exits the parking lot after a number of frames. In the second case, the SOI was not identified as a car in the first half of the track (“no” at state 250H2), was identified as a car during the second half of the track (“yes” at state 250H5), and its centroid was not near an access point in the first frame of the track (“no” at state 250H6). This indicates a car that has exited a parking space but has not yet exited the parking lot.

FIG. 11 is a flowchart of a process 234 of removing from a difference image pixels that represent moving shadows. The method described of removing shadow pictures may be incorporated into the process 230 as shown in FIG. 7. In one embodiment, the RGB components of shadows cast on the parking lot are assumed to be Gaussian distributed, and the mean and covariance matrix are estimated from empirical data. The process 234 begins at a state 234A and proceeds to a state 234B where the system 25 selects a pixel from the difference image. At a state 234C, the system 25 obtains the RGB values for a pixel in the current frame. At a state 234D, the system 25 calculates the Mahalobnis distance MD1 from the pixel in the current frame and the empirically determined shadow mean. The Mahalobnis algorithm and variants of it are well known in the relevant technology. For example, Duda, R. O., et al., Pattern Classification and Scene Analysis, pp. 22-24 (John Wiley & Sons, New York, 1973) provides a suitable discussion of these algorithms.

At a decision state 234E, the system 25 determines whether the MD1 is greater than a threshold value Threshold1. If MD1 is not greater than Threshold1, the process 234 continues at a state 234F where the system 25 removes the corresponding pixel from the difference image. If MD1 is greater than Threshold1, the process 234 moves to a state 234J where the system 25 obtains the RGB values from the previous frame.

At a state 234K, the system 25 calculates the Mahalobnis distance MD2 between the pixel in the previous frame and the empirically determined shadow mean. At a decision state 234L, the system 25 determines whether MD2 is greater than a threshold value Threshold2. If MD2 is not greater than Threshold2, the process 234 moves to the state 234F where the system 25 removes the corresponding pixel from the difference image. If MD2 is greater than Threshold2, or after the system 25 clears the pixel from the difference image at the state 234F, the process 234 moves to a decision state 234M. At the decision state 234M, the system 25 determines whether there are remaining pixels in the difference image for analysis. If there are remaining pixels, the process 234 returns to the state 234B where the next pixel is selected. Otherwise, the process 234 ends at a state 234N where the process flow may continue at the state 235 of the process 230 shown in FIG. 7. It is preferable to apply the Threshold2 to the previous frame because a shadow cast by a moving SOI moves with the SOI. Hence, to ensure that shadow pixels are not considered in the difference image, shadow pixels are removed from both the previous and the current images.

FIG. 12 is a flowchart of a process 236 for extracting and characterizing SOI from a difference image. The process 236 may be employed as part of the process 230 as shown in FIG. 7. The process 236 begins at a start state 236A. The process 236 moves to a state 236B where the system 25 obtains a column vector having elements that each represent the number of lit pixels in each row of the difference image. At a state 236C, the system 25 determines the row element having the maximum value (“MRE”), and at a state 236D the system 25 sets a row filter threshold corresponding to a percentage of the MRE. In one exemplary embodiment, the row filter threshold is set to about 10% to 20%. At a state 236E, the system 25 applies the row filter threshold to the column vector to obtain a binary column vector of “pass” elements. That is, those elements that have values above the row threshold are set to “1” and “pass,” while the elements that do not “pass” the row threshold are set to “0,” for example.

The process 236 proceeds to a state 236F where the system 25 determines the center row of the longest contiguous run of pass elements in the column vector. The system 25 sets the y-coordinate of this row in the difference image as the y-coordinate of the centroid of the feature being extracted from the difference image. The process 236 now moves to a state 236G where the system 25 determines the number of pixels that form the longest contiguous run of lighted pixels in any of the rows belonging to the longest contiguous run of pass elements. The system 25 assigns this value to the length L of the object. Hence, in this manner the system 25 determines the y-coordinate of the centroid of the object, as well as the length of the object.

The process 236 continues at a state 236H where the system derives a row vector having elements that represent the number of lighted pixels in each column of the difference image. At a state 236I, the system identifies the column element having the greatest value (“MCE”), and at a state 236J the system 25 sets a column filter threshold corresponding to a percentage of the MCE. At a state 236K, the system 25 applies the column filter threshold to the row vector to derive a binary row vector of “pass” elements. That is, the elements that have values above the column threshold are set to “1” and “pass,” while the elements that do not “pass” the column threshold are set to “0,” for example.

The process 236 continues at a state 236L where the system 25 determines the center column of the longest contiguous run of pass elements in the row vector. The system 25 sets the x-coordinate of this column in the difference image as the x-coordinate of the centroid of the feature being extracted from the difference image. The process 236 proceeds to a state 236M where the system 25 determines the number of pixels that form the longest contiguous run of lighted pixels in any of the columns belonging to the longest contiguous run of pass elements. The system 25 assigns this value to the width W of the object. Hence, in this manner the system 25 determines the x-coordinate of the centroid of the object, as well as the width of the object.

The process 236 yields a “bounding box” that encloses a feature, i.e., object or structure, from the difference image that represents a structure of interest (“SOI”). The SOI may be characterized by its location, which is given by the x,y-coordinates of its centroid, and by its area, i.e., L×W. There are various well known algorithms for extracting and characterizing structures from binary images such as the difference image discussed here. Consequently, a person of ordinary skill in the relevant technology will readily recognize that the process 236 is merely one such method. In some embodiments, the SOI may be characterized with a number of other geometric measures besides the bounding box area and centroid. For example, the system 25 may compute the SOI's major and minor axes, compactness, number of pixels in its perimeter, number of edges, etc. After the system 25 identifies and characterizes a SOI in the difference image, the process 236 ends at a state 236N from which the process flow may continue at a state 237A of the process 230 shown in FIG. 7.

FIG. 13 is a flowchart of a process 237B for classifying SOI extracted from the difference image. The process 237B may be incorporated into the process 230 as shown in FIG. 5. The system 25 may employ the process 237B to classify a SOI as “car,” if the structure exhibits car-like properties, or as “unknown,” where the system 25 cannot classify the SOI as “car.” The process 237B begins at a state 237B1. At a state 237B2, the system 25 calculates the covariance matrix for the x,y-coordinates of each pixel that forms the SOI. At a state 237B, the system 25 determines the maximum and minimum eigen values of the pixel location data. For convenience of discussion here, the maximum eigen value is designated as λ₁ and the minimum eigen value as λ₂. The length of the principal axis is given by λ₁, and the length of the minor axis is given by λ₂. Computation of the covariance matrix and eigen values of a set of data is well known in the relevant field.

At a decision state 237B4, the system 25 determines whether λ₁ times λ₂ is less than a threshold value Threshold1. The product of these eigen values yields the area of a bounding box containing the SOI. If λ₁ times λ₂ is less than Threshold1, the system 25 determines that the bounding box is too small and, hence, the SOI is not large enough to be a “car.” The process 237B then ends at a state 237B10.

At a decision state 237B5, the system 25 determines whether λ₁ divided by λ₂ is less than a threshold value Threshold2. The ratio of the length of the major axis to the length of the minor axis provides a rough indication of the rectangularity of the bounding box containing the SOI. If λ₁ divided by λ₂ is less than Threshold2, the system 25 determines that the SOI is not rectangular enough to be a “car.” The process 237B then ends at a state 237B10.

If the system 25 determines that the SOI is large and rectangular enough, the process 237B proceeds to a state 237B6. At the state 237B6, the system 25 determines the unit vector Li corresponding to the principal eigen vector of the x,y-coordinate data for the pixels of the SOI. The process moves to a state 237B7 where the system 25 obtains the unit vector N corresponding to a vector orthogonal to a reference line that is parallel to a corresponding parking lot access point. That is, L1 is assumed to indicate the direction of movement of the SOI identified near an access point of the parking lot, and N gives the expected direction that an actual car would be pointed in when accessing the parking lot (i.e., orthogonal to a reference line parallel to the access point).

At a decision state 237B8, the system 25 determines whether the dot product of L1 and N (i.e., <L1,N>) is less than a threshold value Threshold3. If <L1,N> is greater than Threshold3, the system 25 determines that the object's direction does not sufficiently align with the expected direction of an actual car entering the parking lot, and consequently, the SOI cannot be classified as a “car.” The process 237B then ends at a state 237B10. However, if <L1,N> is less than Threshold3, the process 237B moves to a state 237B9 where the system 25 sets the value of the variable “structure,” for example, associated with the SOI to “car.” Hence, if the system 25 finds that the SOI is large and rectangular enough, and it is moving in a direction in which a car would be expected to be moving when entering the parking lot, the system identifies the SOI as a “car.” Otherwise, the system 25 ends at the state 237B10 where the process flow may continue at the state 238 of the process 230 shown in FIG. 7.

While exemplary systems and methods have been describe above, the person of ordinary skill in the relevant technology will readily recognize that other embodiments of the invention may include more or fewer devices, more or fewer modes of communication, or devices or modes of communication in a different form or of a different type as shown in the system architecture of FIG. 1 or of FIG. 3. Still further embodiments may combine the functions of two or more of the devices shown in FIG. 1 or FIG. 3 into fewer devices, or the function of a single device or grouping of devices may be partitioned so they are performed utilizing a greater number of devices. In yet other embodiments, the processes described with reference to FIGS. 4 to 13 may include fewer or more subprocesses and be configured as part of various combinations of software modules. Such additional embodiments are contemplated and fully within the scope of the present invention.

As described herein, the invention fills the longstanding need in the technology for a system that provides automated monitoring, tracking, reporting and payment enforcement of vehicles in a parking lot. In summary, a system providing the above capabilities includes numerous benefits and advantages, generally including the following non-exhaustive list:

Parking lots utilizing this system can be unattended, thereby substantially decreasing operating costs;

Vehicles belonging to parking fee offenders can be ticketed on the spot, thereby increasing revenue;

Vehicle drivers are more likely to make immediate payments than to risk being ticketed, thereby further increasing revenue; and

Cameras or other vehicle sensing devices serve as a security device, thereby decreasing insurance costs, decreasing capital costs due to decreased vandalism, and decreasing theft rate.

While the above detailed description has shown, described, and pointed out novel features of the invention as applied to various embodiments, it will be understood that various omissions, substitutions, and changes in the form and details of the device or process illustrated may be made by those skilled in the technology without departing from the scope of the invention. The scope of the invention is indicated by the appended claims rather than by the foregoing description. All changes that come within the meaning and range of equivalency of the claims are to be embraced within their scope.

What is claimed is:

1. A system for tracking vehicles in a parking lot, the system comprising:
a vehicle sensing device configured to monitor movement of vehicles in the parking lot;
a computer device configured to receive images from the vehicle sensing device, digitally process the images, and produce parking lot information;
a pay station device configured to receive payment for parking spaces and transmit payment information to the computer device;
a modem configured to transmit the parking lot information to a first data transfer service;
a central computer and data storage system configured to receive the parking lot information from the first data transfer service, archive portions of the parking lot information, maintain a central database, communicate with a client computing device via a network, communicate with a credit card processing computing device via the network, and send lack of payment alerts to an attendant via a second data transfer service; and
a central control station configured to receive portions of the parking lot information from the central computer and data storage system and perform monitoring functions of the parking lots.

2. A method of tracking vehicles in a parking lot, the method comprising:
monitoring movement of vehicles in the parking lot;
receiving images of the monitored movement, digitally processing the images, and producing information indicative of parking lot status;
receiving payment for parking spaces and transmitting payment information to another location;
transmitting the parking lot status information to a first data transfer service, receiving the parking lot status information from the first data transfer service, archiving portions of the parking lot information, maintaining a central database, communicating with a client computing device via a network, communicating with a credit card processing computing device via the network, and sending lack of payment alerts to an attendant via a second data transfer service; and
receiving portions of the parking lot status information from the central computer and data storage system and performing monitoring functions of the parking lots.

3. A method of tracking vehicles in a parking lot, the method comprising:
capturing a first image of the parking lot;
transmitting the first image to a parking lot computing device;
processing the first image so as to produce a second image of moving objects in the first image;
processing the second image, including filtering vehicles based on size, so as to produce positions of recently-moved vehicles;
comparing the positions of recently-moved vehicles to known lot space positions;
identifying space positions with newly-arrived or departed vehicles;
receiving lot payment information, determining if payment was received from the newly-arrived vehicles; and
alerting an attendant if no payment was received from the newly-arrived vehicles.

4. A system for tracking vehicles in a parking lot, the system comprising:
a vehicle sensing device configured to generate a parking lot image, process the image, and produce parking lot information;
a pay station device configured to receive payment for parking spaces and produce payment information; and
a data processing system configured to receive parking lot information and payment information, and produce correlated information from the parking lot information and payment information.

5. The system of claim 4, further comprising modules that correlate parking lot information and payment information with client information for display on a client computing device.

6. The system of claim 5, wherein the system correlates information that includes parking lot monitoring information.

7. The system of claim 5, wherein the system correlates information that includes payment deficiency alert information.

8. A method of tracking vehicles in a parking lot, the method comprising:
producing images of the parking lot, processing the images and producing parking lot information;
receiving payment for parking spaces and producing payment information;
receiving the parking lot information and payment information, and producing payment deficiency alert information.

9. A method of tracking vehicles in a parking lot, the method comprising:
generating an image of the parking lot;
processing the image to produce newly-arrived vehicle position information;
receiving lot payment information;
determining if payment was received for the newly-arrived vehicle; and
generating alert information if no payment was received for the newly-arrived vehicle.

10. The method of claim 9, wherein processing the image comprises producing moving object information.

11. The method of claim 10, wherein processing the image comprises producing space usage information.

12. A system for detecting unauthorized use of a parking lot, the system comprising:
a sensing device that captures images of the parking lot;
a payment device that receives payment input, wherein the payment input comprises information associated with payments for use of the parking lot;
a computing device for receiving the images and the payment input;
a software program executing on the computing device for processing the images to produce parking lot information, correlating the parking lot information with the payment input, and generating alert information when the parking lot information and the payment input do not correlate according to a predefined criterion.

13. The system of claim 12, further comprising a first communication device connected to the computing device for forwarding the alert information to a second communication device.

14. The system of claim 13, wherein the first communication device comprises a transceiver configured to forward messages over a communications network.

15. The system of claim 13, wherein the second communication device comprises a mobile transceiver configured to receive messages over a communications network.

16. A method of detecting unauthorized use of a parking lot, the method comprising:
processing images of the parking lot to produce parking lot information, wherein the parking lot information comprises information about the movement of vehicles in the parking lot;
receiving payment for the use of parking spaces of the parking lot and based thereon producing payment information; and
comparing the parking lot information with the payment information to determine unauthorized use of the parking lot.

17. The method of claim 16, further comprising producing alert information indicative of unauthorized use of the parking lot.

18. The method of claim 17, further comprising forwarding the alert information to a roaming communications device

19. A system for monitoring parking lot usage, the system comprising:
means for generating parking lot images;
means for processing the images;
means for producing parking lot usage information, wherein the parking lot usage information comprises information about the movement of vehicles in the parking lot;
means for receiving payment input, wherein the payment input comprises information about payment for usage of the parking lot; and
means for correlating the parking lot information and the payment input to identify discrepancies between usage and payment.

20. A system for monitoring parking lot usage, comprising:
at least one image sensor directed at a parking lot;
a processor receiving images from the at least one image sensor; and
software, executed by the processor, to identify and track vehicles in the images and correlate the vehicle tracks with data indicative of payment for parking lot usage.

21. A method of monitoring status of vehicles in a zone of interest, comprising:
generating an image of vehicles in the zone of interest;
processing the image to produce vehicle information;
comparing the vehicle information to predetermined parameters associated with the zone of interest; and
generating status information based on the comparing.

22. The method of claim 21, wherein the zone of interest comprises a parking lot or parking structure, and wherein processing the image comprises producing information associated with the number of vehicles that have entered, exited, or remain in the parking lot or parking structure.

23. The method of claim 21, wherein processing the image comprises producing information associated with either (i) the speed of a vehicle or (ii) the position of the vehicle with respect to a traffic light, or both.
